(19) United States
(12) Patent Application Publication
(10) Pub. No.: US 2013/0044866 A1
(43) Pub. Date: Feb. 21, 2013

(54) X-RAY GENERATING DEVICE EMPLOYING A MECHANICAL ENERGY SOURCE AND METHOD

(71) Applicant: Gereon Vogtmeier, Aachen (DE)

(72) Inventor: Gereon Vogtmeier, Aachen (DE)

(73) Assignee: KONINKLIJKE PHILIPS ELECTRONICS N.V., EINDHOVEN (NL)

(21) Appl. No.: 13/696,332

(22) PCT Filed: Apr. 28, 2011
(86) PCT No.: PCT/IB11/51868

§ 371 Date: Nov. 6, 2012

(30) Foreign Application Priority Data
May 7, 2010 (EP) 10162277.7

(51) Int. Cl. H05G 1/10; H02N 2/18

(52) U.S. Cl. 378/101; 310/339

(57) ABSTRACT

The present invention relates to the generation of X-ray-radiation (10), in particular to an X-ray generating device (2) adapted for interventional imaging. Brachytherapy requires for miniaturized X-ray generating devices (2) suitable for in vivo operation. In particular, an X-ray generating device (2) arranged within a patient's body requires dedicated cabling for providing both a high voltage and/or cooling to the X-ray source. Accordingly, an X-ray generating device (2) is provided that employs a mechanical energy source for local generation of a high voltage within the X-ray generating device (2) and further employing the mechanical energy source for cooling of the X-ray source.

### FIELD OF THE INVENTION

The present invention relates to X-ray generating technology in general. In particular, the present invention relates to an X-ray generating device employing a mechanical energy source and method.

### BACKGROUND OF THE INVENTION

X-ray sources for e.g. brachytherapy and other applications in the field of interventional imaging, demand for specialized X-ray generating devices. In particular, internal radiography requires miniaturized X-ray sources or X-ray generating devices for generating X-ray-radiation possibly even within a patient's body, i.e. in vivo.

Thus, there may be a need for providing a reliable miniature X-ray generating device, in particular for generating X-ray-radiation within a patient's body while minimizing the risk to the patient, imposed e.g. by providing a required high voltage feed to the X-ray generating device and possibly by heat occurring within the X-ray source during operation.

Document GB 969,842 describes a piezoelectrically powered X-ray tube.

IEEE Spectrum, Prachi Patel, “Music-Powered Microfluidics”, July 2009, http://spectrum.ieee.org/biomedical/diagnostics/musicpowered-microfluidies, describes an acoustically driven microfluidic microelectromechanical system.

### SUMMARY OF THE INVENTION

Accordingly, an X-ray generating device employing a mechanical energy source and method according to the independent claims is provided.

Preferred embodiments of the present invention may be derived from the dependent claims.

According to the present invention, an X-ray generating device is provided that employs a mechanical energy source, e.g. a fluid source, for local generation of a high voltage within the X-ray generating device and further employs the mechanical energy source for cooling of the X-ray source.

### BRIEF DESCRIPTION OF THE DRAWINGS

FIG. 1 shows an exemplary embodiment of an X-ray generating device according to the present invention;

FIGS. 2a-h show exemplary operational embodiments of a mechanical provisioning element according to the present invention;

FIG. 3 shows an exemplary embodiment of a method for generating X-ray-radiation employing electrical energy generated by a mechanical energy source; and

FIG. 4 shows an exemplary embodiment of a method for generation of a high voltage employing a mechanical energy source.

### DETAILED DESCRIPTION OF THE EMBODIMENTS

One aspect when considering miniaturization of an X-ray generating device may be seen in the generation of a high voltage for the generation of X-ray-radiation within a possibly small, evacuated housing while maintaining a desired temperature of the X-ray generating device. In case an external high voltage source is employed, a dedicated cable connection may be required from the external high voltage source to the X-ray generating device. In case the X-ray generating device is, at least temporarily, arranged within a patient's body, the according cabling is required to run through part of the patient's body to the X-ray generating device within.

Accordingly, it may be required that such high voltage cabling is embodied as a rather slim cable, so limiting its maximum isolation capabilities of a cable and isolator combination of the cabling. Furthermore, since generation of X-ray-radiation possibly also generates a substantive amount of heat associated with a temperature regularly unsuitable for in body operation, an X-ray generating device for interventional imaging may be required to be cooled. Such a cooling may employ a fluid, e.g. a liquid or gaseous substance, also provided to the X-ray generating device. The provision of a cooling fluid may necessitate an external fluid source so that the cooling fluid would have to be transported from outside the patient's body to the X-ray generating device arranged within the patient's body as well and heated cooling fluid may also be required to be removed from the X-ray source to the outside. Such a conduction of cooling fluid may be limited by a diameter of the cabling provided to the X-ray generating device through the patient's body.

The gist of the invention may be seen in the local generation of a high voltage, in particular within the X-ray generating device, thus possibly avoiding or at least limiting issues arising with high voltage cabling insulating. In particular, by employing local mechanical energy, e.g. a pressure, stress or force impacting on a mechanical electrical conversion element, electrical energy, in particular a high voltage, may be generated within the X-ray generating device without the need for providing an external high voltage feed. One example of an according mechanical force may be a fluid substance provided to the X-ray generating device from outside the patient's body to generate a local pressure for generating a high voltage by employing a mechanical electrical conversion element.

Thus, electrical energy is generated by a mechanical energy source being provided to a mechanical-electrical conversion element, in particular in a modulated way. The so generated energy, in particular a high voltage, may be provided to at least one of an electron emitting element and an electron collecting element for accelerating electrons for the generation of X-radiation.

At the same time, the fluid employed for generating the high voltage may also be employed as a cooling aid, e.g. a cooling liquid or cooling gas.

Both an electron emitting element, e.g. a cathode element, and an electron collecting element, e.g. an anode element, may be subjected to a cooling employing the mechanical energy source or fluid.

An according cooling may sustain a temperature of substantially 37° C. for an in-body X-ray generating device for avoiding damage to tissue surrounding the X-ray generating device during operation, i.e. during the generation of X-ray-radiation. One example may be employing a piezo high voltage generator adapted for generating a high voltage when subjected to a force or pressure. The pressure, or generally speaking the mechanical energy source, may be provided by employing a microfluidic microelectromechanical (MEMS) element arranged within the evacuated housing of the miniature X-ray generating device. The mechanical energy source provided to the mechanical provisioning element, e.g. the microfluidic MEMS element, may be modulated for generating a high pressure employing liquid droplets. This high pressure employed in combination with the piezo element may be employed for generating a high voltage, which in turn may be employed for electron acceleration between an electron emitting element and an electron collecting element for the generation of X-ray-radiation.

A variation of the MEMS modulator sequences may modify and control the pressure and thus may control the high voltage, in particular a high voltage sequence. A high voltage sequence may be understood as a plurality of possible high voltage values, which may be individually set. A MEMS modulator sequence may be understood as a pressure sequence when providing the mechanical energy source to the mechanical electrical conversion element for obtaining a dedicated high voltage value.

By controlling and/or modulating the high voltage sequence, a dedicated, well-defined plurality of spectra of possibly generated beams of X-ray-radiation may be controlled and generated, in particular comprising individual defined energies.

The pulse sequence, i.e. the timed switching on and off of the high voltage, may be controlled by the mechanical provisioning element and/or the mechanical energy source provided to the mechanical provisioning element and subsequently to the mechanical-electrical conversion element. Accordingly, the value of the high voltage generated and thus the dedicated spectrum may be controlled.

The modulation may be provided externally by the mechanical energy source and/or may be provided by the mechanical provisioning element. A control element may be present within the housing for controlling the provision of the mechanical energy source to the mechanical-electrical conversion element by at least one of the mechanical provisioning element, the fluid provisioning element and the fluid control element.

The X-ray generating device may comprise a mode of operation, which is adapted for continuous generation of X-ray-radiation. In other words, a substantially continuous or also pulsed mode of operation is achievable, by continuous or pulsed impingement of the mechanical electrical conversion element with fluid droplets. Thus, the generation of X-ray-radiation may be considered to be only dependent on the sufficient stream of fluid or mechanical energy source, resulting in a substantially instantaneous generation of high voltage and subsequently X-ray-radiation. The stream of fluid may be controlled by controlling, e. g. externally, one of a feed of fluid to the X-ray generating device and a control of the fluid provisioning element within the evacuated housing, e.g. by an acoustic signal, possibly having at least one dedicated frequency.

Also, the X-ray generating device may generate a high voltage by either compression or decompression the high voltage generating element. In other words, a spontaneous compression may result in generating a high voltage or a mechanical force may be provided to the mechanical electrical conversion element, which is subsequently released spontaneously for the generation of a high voltage.

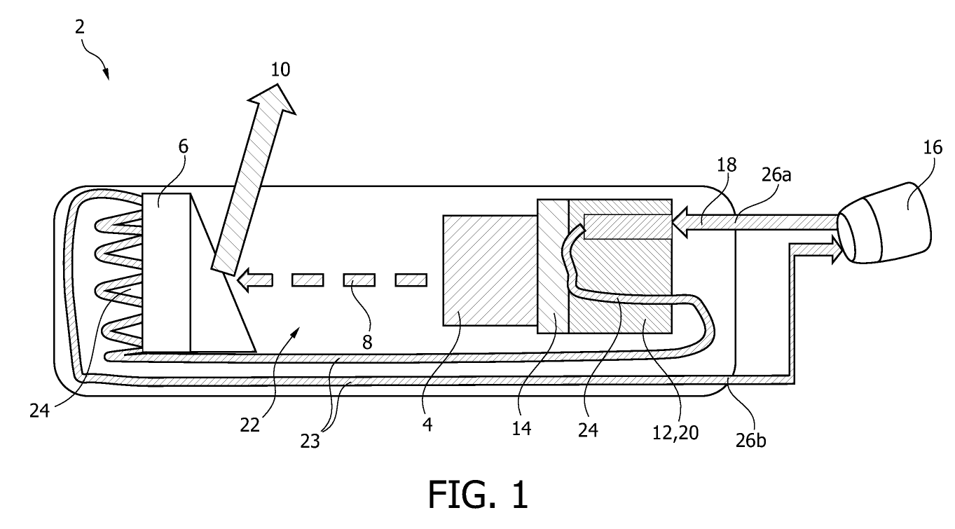

Now referring to FIG. 1, an exemplary embodiment of an X-ray generating device according to the present invention is depicted.

The X-ray generating device 2 according to FIG. 1 comprises an electron emitting element 4 or a cathode element, from which an electron beam 8 comprising individual electrons 8 is accelerated towards an electron collecting element 6 or anode element. A potential is arranged between the electron emitting element 4 and the electron collecting element 6 for the acceleration of electrons 8. Electrons 8 impinging on the electron collecting element 6 generate X-ray-radiation 10, which penetrates housing 22 in a defined direction as indicated in FIG. 1.

The electron emitting element 4 and the electron collecting element 6 may be considered to constitute a conventional X-ray source. However, a carbon nanotube based cold emitter may also be employed for electron beam generation.

A high voltage is required for generating an acceleration potential between the electron emitting element 4 and the electron collecting element 6, with a mechanical electrical conversion element 14, e.g. a piezo element 14 being employed for generating the required high voltage. An according mechanical electrical conversion element 14 may be seen as employing a mechanical energy source, e.g. a pressure or force provided to the mechanical electrical conversion element 14, which mechanical energy is subsequently converted to an electrical energy. By employing the electrical energy generated by the mechanical electrical conversion element 14, a high voltage is generated possibly, resulting in a potential between electron emitting element 4 and electron collecting element 6 for acceleration of electrons 8.

The mechanical energy source or force may be provided by a mechanical provisioning element 12, which is adapted for providing the mechanical energy source or force to the mechanical electrical conversion element 14.

A mechanical energy source 16 or fluid source 16 is arranged outside the evacuated housing 22. The fluid source 16 provides a fluid via a first mechanical opening 26a or first fluid opening 26a from the outside of the evacuated housing 22 to the inside and in particular to the mechanical provisioning element 12 by fluid provisioning element 18. Accordingly, by fluid provisioning element 18, fluid is provided to the mechanical provisioning element 12, possibly having a dedicated pressure for providing a mechanical energy source to the mechanical provisioning element 12. The fluid of the fluid source 16 may provide both energy required for generating a high voltage by the mechanical electrical conversion element 14 or piezo element 14 and also provide for cooling at least one of the mechanical provisioning element 12, the mechanical electrical conversion element 14, the electron emitting element 4 and the electron collecting element 6. The fluid may be circulated within the evacuated housing by employing tubing 23.

The mechanical provisioning element 12 may further comprise a fluid control element 20 for a controlled impingement of fluid, e.g. fluid droplets, having a dedicated pressure, velocity and/or amplitude for generating, in particular controlling, the generation of a high voltage by the mechanical electrical conversion element 14.

The mechanical provisioning element 12 and the fluid control element 20 may be arranged as a microfluidic pressure element, e.g. a microelectromechanical system fluidic pressure element or modulator. The modulation of the fluid droplets may be controlled e.g. by an acoustic element 21 or speaker, which in FIG. 1 is exemplarily arranged outside of the evacuated housing 22, but may as well be arranged within the evacuated housing 22, possibly being attached to or integrated within the mechanical provisioning element 12.

While it should be noted, that in accordance with the present invention no dedicated high voltage feed is required to be supplied to the X-ray generating device 2 from the outside, further line connections or cables for controlling and/or providing a power supply to at least one of the mechanical provisioning element 12, the fluid provisioning element 18, the fluid control element 20 and the acoustic element 21 may be provided to the X-ray generating device 2. According line connections may be provided in addition to or incorporated within the connection from the mechanical energy source 16. E.g. a tube for providing and removing of a fluid may further comprise cables for providing an energy source and/or control signals to the inside of the X-ray generating device 2. Is should be noted, that the power supply for at least one of the mechanical provisioning element 12, the fluid provisioning element 18, the fluid control element 20 and the acoustic element 21 may be considered to be substantially weaker that a power supply, which would be required for providing a high voltage for generation of X-ray-radiation. An according power supply may be referred to as a weak power supply. Providing a controlling and an according weak power supply may also be conceivable by employing RF transmission of control signals and/or energy from the outside, e.g. through body tissue, to the X-ray generating device 2.

The housing the X-ray generating device 2 may comprise an evacuated housing 22 arranged within an additional non-evacuated housing. At least one of the mechanical provisioning element 12, the fluid provisioning element 18, the fluid control element 20, the mechanical-electrical conversion element 14 and the acoustic element 21 may be arranged within the evacuated housing 22 as depicted in FIG. 1 or may also be arranged within the non-evacuated housing but outside the evacuated housing 22. Lines for supply of a high voltage and/or for providing and removing of a cooling fluid pay penetrate the evacuated housing 22 within the non-evacuated housing.

Acoustic waves emanating from the acoustic element 21 may thus control the mechanical energy source 16 or fluid source 16 impacting on the mechanical electrical conversion element 14. By controlling any one of the parameters of an amplitude, a velocity and a pressure of the fluid source 16 or fluid droplets, the generation of the high voltage may be controlled as well, in particular a high voltage sequence, resulting in a plurality or spectrum of possibly individual generated X-ray beams 10, having individual, distinct energies.

The fluid, after the generation of the high voltage, may be provided by tubing 23 to the electron collecting element 6 or the anode of the X-ray generating device 2 for cooling of the anode 6. Thus, heat may be conducted away from the anode by employing the fluid within tubing 23. A second mechanical opening 26b or second fluid opening 26b allows to remove the liquid from within the evacuated housing 22.

The first mechanical opening 26a and the second mechanical opening 26b may e.g. be combined in a single mechanical opening, to which a cabling is attached to for providing incoming cool fluid to the evacuated housing 22 of the X-ray generating device 2 and for removing outgoing hot fluid from the evacuated housing 22 of the X-ray generating device 2. Both openings are in particular be required to be vacuum tight with respect to the vacuum within housing 23.

It may be understood that in particular no electrical energy but only mechanical energy is provided to the X-ray generating device 2 for the generation of X-ray-radiation 10. The required high voltage for the X-ray generation via electron acceleration is generated from the electrical mechanical conversion element 14 or piezo element 14, in particular a piezo based high voltage generator, that is powered by mechanical forces, which are generated and/or modulated by the microelectromechanical microfluidic pressure modulator. The incoming pressurized cooling fluid, a liquid or gas, may be employed for pressure generation in one step and at the anode for cooling the anode material in a further step. The sequence may of course also be reversed.

Different material combinations may be employed for the high voltage generator, e.g. lead zirconate titanate piezoelectric ceramics.

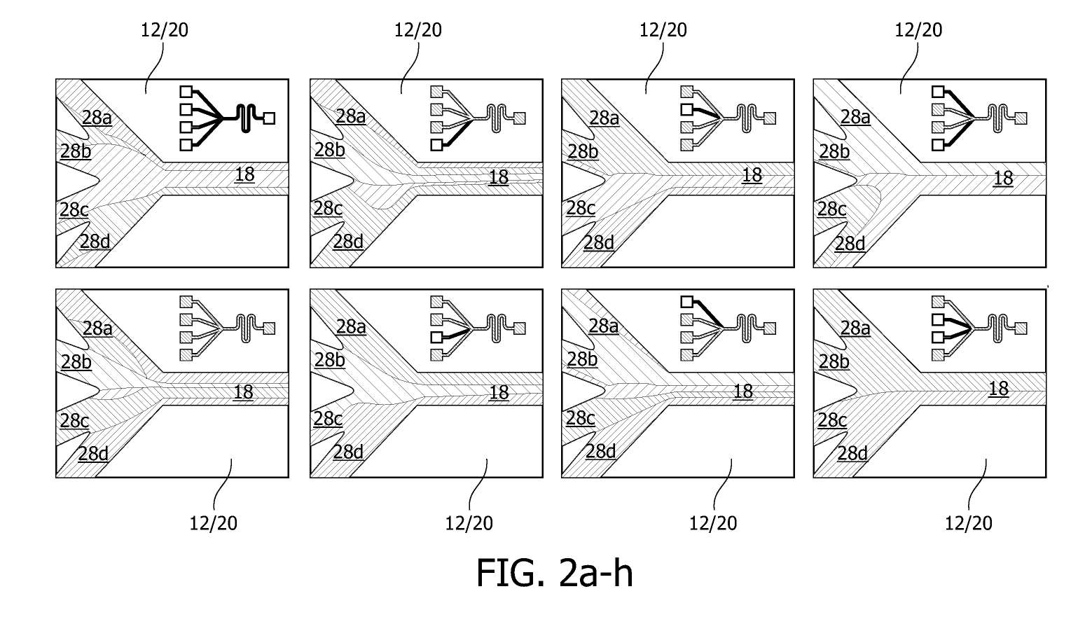

Now referring to FIG. 2, exemplary operational embodiments of the mechanical provisioning element according to the present invention is depicted.

FIGS. 2a-h show a microelectromechanical microfluidic element employing an element having four individual fluid channels 28a-d. Depending on which channel currently is activated, e.g. by employing an external acoustic wave, the amount, amplitude and velocity of droplets emanating from the individual fluid channels 28a-d may be controlled, so controlling the generation of high voltage by the mechanical electrical conversion element 14.

E.g., musical tones may move the individual droplets along the individual channels 28a-d. By combining tones and applying them at appropriate times, the fluid may be moved along multiple fluid channels 28a-d and may even be mixed, split and sorted. The individual channels may comprise individual physical properties, e.g. length, diameter and in particular an individual resonance frequency, for individual actuation employing an individual acoustic wave or tone. In other words, each fluid channel 28a-d may comprise a precisely determined length and diameter, resulting in a specific resonance frequency for each fluid channel 28a-d. E.g. by employing four individual frequencies, the individual fluid channels 28a-d may be individually controlled.

Thus, by combining frequencies, even a plurality of individual fluid channels 28a-d may be controlled substantially simultaneously. Each fluid channel 28a-d may resonate at a specific frequency and may amplify the resonance vibrations so resulting in a build-up of inside pressure. Increasing the amplitude of the frequency, acoustic wave or sound may result in an increased movement velocity, while increasing the duration of the acoustic wave may allow to move the droplets farther within the fluid channel 28a-d. In other words, a single driving force may be employed for controlling a plurality of fluid flows within the plurality of fluid channels 28a-d. The acoustic element 21 may e.g. be a piezoelectric transducer, converting electrical signals into acoustic waves.

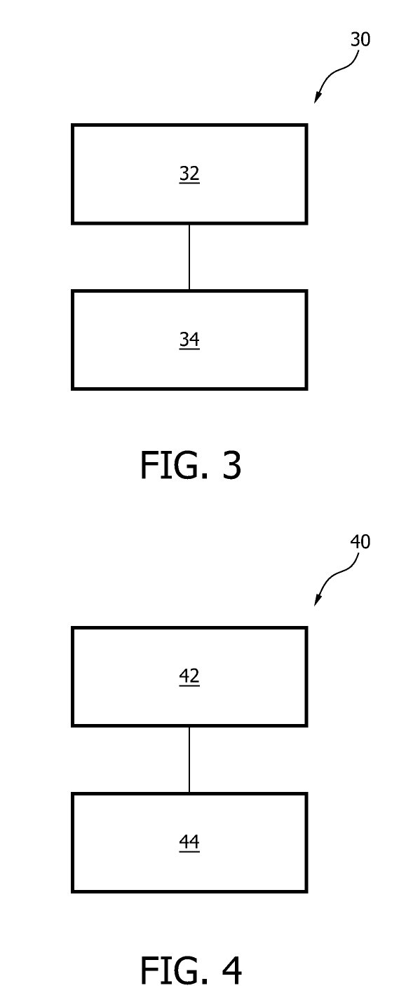

Now referring to FIG. 3 an exemplary embodiment of the method for generating X-ray-radiation employing a mechanical energy source is depicted.

The method 30 of generation of X-ray-radiation employing a mechanical energy source comprises providing 32 from outside of an evacuated housing 22 a mechanical energy source to a mechanical-electrical conversion element 14 for the generation of electrical energy and providing 34 the electrical energy to at least one of an electron emitting element 4 and a electron collecting element 6 for acceleration of electrons 8 between the electron emitting element 4 and the electron collecting element 6. The electron emitting element 4 and the electron collecting element 6 are operatively coupled for the generation of X-ray-radiation 10.

Now referring to FIG. 4, an exemplary embodiment of a method for generation of a high voltage employing a mechanical energy source is depicted.

The method 40 of generation of a high voltage employing a mechanical energy source comprises providing 42 a mechanical energy source to a mechanical-electrical conversion element 14 for the generation of electrical energy and modulating 44 the mechanical energy source for generation of a high voltage.

It should be noted that the term “comprising” does not exclude other elements or steps and that the “a” or “an” does not exclude a plurality. Also elements described in association with different embodiments and in particular different claimed entities may be combined.

It should also be noted, that reference signs in the claims shall not be construed as limiting the scope of the claims.

### LIST OF REFERENCE SIGNS

2 X-ray generating device
4 Electron emitting element
6 Electron collecting element
8 Electrons/electron beam
10 X-ray-radiation
12 Mechanical provisioning element
14 Mechanical electrical conversion element/piezo element/high voltage generating element
16 Mechanical energy source/fluid source
18 Fluid provisioning element
20 Fluid control element
21 Acoustic element/Speaker
22 Evacuated housing
23 Tubing
24 Cooling
26a,b First, second mechanical opening
28a-d Fluid channels
30 Method for generating X-ray-radiation employing electrical energy generated by a mechanical energy source
32 Step: Providing a mechanical energy source
34 Step: Providing electrical energy to electron emitting element/electron collecting element
40 Method of generation of a high voltage employing a mechanical energy source
42 Step: Providing a mechanical energy source
44 Step: Modulating mechanical energy source

1. X-ray generating device (2) employing a mechanical energy source, comprising
an electron emitting element (4);
an electron collecting element (6);
a mechanical provisioning element (12);
a mechanical-electrical conversion element (14); and
a housing;
wherein the mechanical provisioning element (12) is adapted for providing a
mechanical energy source to the mechanical-electrical conversion element (14);
wherein the mechanical-electrical conversion element (14) is adapted for conversion of mechanical energy provided by the mechanical provisioning element (12) to electrical energy;
wherein the electrical energy is adapted for accelerating electrons between the electron emitting element (4) and the electron collecting element (6);
wherein the electron emitting element (4) and the electron collecting element (6) are operatively coupled for the generation of X-ray-radiation (10); and
wherein the mechanical energy source is provided from outside of the housing.

2. X-ray generating device according to claim 1,
wherein the mechanical provisioning element (12) comprises at least one of a fluid provisioning element (18) and a fluid control element (20).

3. X-ray generating device according to claim 1,
wherein the fluid control element (20) is adapted for providing a fluid to the mechanical-electrical conversion element (14).

4. X-ray generating device according to claim 2,
wherein the fluid control element (20) is one element out of the group consisting of a micro-fluidic pressure element, a MEMS micro-fluidic pressure element, a micro-fluidic pressure modulator and a MEMS micro-fluidic pressure modulator.

5. X-ray generating device according to claim 1,
wherein the mechanical-electrical conversion element (14) is one element out of the group consisting of a high voltage generating element (14) and a piezo high voltage generating element (14).

6. X-ray generating device according to claim 2,
wherein the fluid provisioning element (18) and the fluid control element (20) are operatively coupled for providing mechanical fluid energy to the mechanical-electrical conversion element (14) for generating electrical energy.

7. X-ray generating device according to claim 2,
wherein the fluid control element (20) is adapted for controlling a fluid flow to the mechanical-electrical conversion element (14) for controlling high voltage generation.

8. X-ray generating element according to claim 7,
wherein the controlling of the fluid flow employs at least one of an acoustic element (21) and acoustic energy, in particular an acoustic wave.

9. X-ray generating device according to claim 8;
wherein controlling of the fluid flow comprises controlling at least one of the frequency, the amplitude and the duration of the acoustic wave for influencing at least one of an amount of a fluid, an intensity of a fluid and a velocity of a fluid of the fluid flow provided to the high voltage generating element (14) for influencing the generation of high voltage.

10. X-ray generating device according to claim 1,
wherein at least one of the mechanical provisioning element (12), the fluid provisioning element (18) and the fluid control element (20) is further adapted for providing a fluid to at least one of the electron emitting element (4) and the electron collecting element (6), in particular for cooling at least one of the electron emitting element (4) and the electron collecting element (6).

11. X-ray generating device according to claim 1,
the housing further comprising:
a first mechanical opening (26a) for providing the mechanical energy source into the housing; and
a second mechanical opening (26b) for providing the mechanical energy source from the housing; in particular wherein the mechanical energy source is a fluid and wherein the first mechanical opening (26a) and the second mechanical opening (26b) are adapted as fluid openings (26a,b).

12. X-ray generating device according to claim 1,
wherein the X-ray generating device (2) is a portable X-ray generating device (2), in particular adapted for in vivo or in-body generation of X-ray-radiation (10).

13. X-ray generating device according to claim 1,
wherein the X-ray generating device (2) comprises a mode of operation, which is adapted for continuous generation of X-ray-radiation (10) and/or
wherein the high voltage generation comprises compressing and/or decompressing the high voltage generating element (14).

14. Method (40) of generation of a high voltage employing a mechanical energy source;
providing (42) a mechanical energy source to a mechanical-electrical conversion element (14) for the generation of electrical energy; and
modulating (44) the mechanical energy source for generation of a high voltage.

15. Method (30) of generation of X-ray-radiation employing electrical energy generated by a mechanical energy source;
providing (32) from outside of a housing a mechanical energy source to a mechanical-electrical conversion element (14) for the generation of electrical energy; and
providing (34) the electrical energy to at least one of an electron emitting element (4) and an electron collection element (6) for acceleration of electrons (8) between the electron emitting element (4) and the electron collection element (6);
wherein the electron emitting element (4) and the electron collecting element (6) are operatively coupled for the generation of X-ray-radiation (10).
